(19) United States
(12) Patent Application Publication
(10) Pub. No.: US 2016/0285299 A1
(43) Pub. Date: Sep. 29, 2016

(54) METHOD AND APPARATUS FOR LOW POWER WIRELESS DOCKING DISCOVERY

(71) Applicant: Intel Corporation, Santa Clara, CA (US)

(72) Inventors: Francois Amand, Nice (FR); David Bercovitz, Pegomas (FR); Remi Laudebat, Sophia Antipolis (FR)

(21) Appl. No.: 14/669,649

(22) Filed: Mar. 26, 2015

(51) Int. Cl. H02J 7/02; H04B 7/26

(52) U.S. Cl. CPC H02J 7/025; H04B 7/26; H02J 7/027; H02J 2007/0096

(57) ABSTRACT

The disclosure generally relates to method, apparatus and a system to leverage wireless docking station discovery to provide fast and efficient wireless connection. In an exemplary embodiment, a wireless device detects a power beacon from a wireless charging station. The power beacon detection is used as a leverage to initiate a BLE signal from the mobile station to the wireless charging station. The wireless charging station maybe associated with a wireless docking station. The mobile device's identification information can be used to determine whether the mobile device is paired with the docking station. If the mobile device is paired with the docking station, then wireless communication between the mobile device and the charging station may commence.

### BACKGROUND

1. Field

The disclosure generally relates to method and apparatus for low power wireless docking discovery. More particularly, the disclosure relates to method, apparatus and system to leverage wireless docking station discovery to provide fast and efficient wireless connection.

2. Description of Related Art

Wireless charging or inductive charging uses a magnetic field to transfer energy between two devices. Wireless charging is implemented at a charging station. Energy is sent from one device to another device through an inductive coupling. The inductive coupling is used to charge batteries or run the receiving device. The Alliance for Wireless Power (A4WP) was formed to create industry standard to deliver non-radiative, near field, magnetic resonance from the Power Transmitting Unit (PTU) to a Power Receiving Unit (PRU).

The A4WP defines five categories of PRU parameterized by the maximum power delivered out of the PRU resonator. Category 1 is directed to lower power applications (e.g., Bluetooth headsets). Category 2 is directed to devices with power output of about 3.5 W and Category e devices have an output of about 6.5 W. Categories 4 and 5 are directed to higher-power applications (e.g., tablets, netbooks and laptops).

Induction chargers of A4WP use an induction coil to generate a magnetic field from within a charging base station, and a second induction coil in the portable device takes power from the magnetic field and converts the power back into electrical current to charge the battery. In this manner, the two proximal induction coils form an electrical transformer. Greater distances between sender and receiver coils can be achieved when the inductive charging system uses resonant inductive coupling. Resonant inductive coupling is the near field wireless transmission of electrical energy between two coils that are tuned to resonate at the same frequency. There has been a proliferation in wireless charging stations which also provide wireless docking for portable devices.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows a wireless environment for implementing an embodiment of the disclosure;

FIG. 2 schematically illustrates an implementation according to one embodiment of the disclosure;

FIG. 3 shows a discovery process according to one embodiment of the disclosure;

FIG. 4 illustrates the significant improvement in connection speed provided by the disclosed principles when compared to conventional methods;

FIG. 5 shows a flow-diagram for implementing an embodiment of the disclosure; and

FIG. 6 illustrates an apparatus according to one embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, March 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60GHz Band, 28 December, 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HDTM specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

In certain embodiments, the disclosure is directed to a procedure to discover wireless docking stations, while operating the connecting device (mobile device) at low power. While wired docking stations use physical connections to make the pairing between the mobile device and the docking station, wireless docking requires other methods to perform the discovery. Conventional methods require user-initiated discovery procedures that depend on conventional wireless technologies, including Wi-Fi Direct, Bluetooth or Near-Field Communication (NFC).

Conventional user-initiated discovery methods are not efficient and often require user intervention or initiation. Moreover, the conventional user-initiated discovery methods can be time consuming. For example, the Wi-Fi direct detection takes about 5-10 seconds before a communicating device is detected and communication is established. These and other inefficiencies detract from the user experience. With the proliferation of wireless docking stations, the users experience delay from the moment they are at or near the docking station until the time the mobile device is online. The addition of wireless charging to the wireless docking station can be used to reduce this delay.

In one embodiment, the disclosure leverages the proximity usage of wireless charging as a source of wireless docking discovery. Each wireless charging station is associated to a unique wireless docking device and is typically configured to operate at a mobile device proximity of about 10 cm. This is to avoid false detection by the mobile device. Proximity detection may be based on A4WP-Rezence to allow fast (less than 200 ms) and intelligent handover (including security check) to faster wireless interfaces like Wi-Fi, Wi-Gig, etc.

The conventional methods for addressing wireless connectivity between a mobile device and docking stations (which may include wireless charging stations) have failed to provide quick and efficient connectivity solutions. For example, NFC provides proximity detection and pairing. While NFC provides fast discovery, both the docking station and the mobile device must be equipped with NFC hardware and software. NFC does not provide wireless charging capability for different mobile devices.

Wi-Fi also provides proximity detection and connection procedures. However, Wi-Fi discovery and connection require user interaction due to the extended service range. In addition, Wi-Fi discovery and connection can be relatively slow and time consuming (i.e., 5-10 seconds). Finally, BT/BLE can be used as discover and connection method. However, BT/BLE technology results in many false discoveries (due to many available BT/BLE devices) thereby delaying connection. The disclosed embodiments overcome these and other inefficiencies by configuring a mobile device to discover and connect to a wireless docking station upon detecting a wireless charger associated with the dockings station. Because the wireless charging station is detectable much faster than wireless signal detection, the discovery of the wireless charging station can be leveraged to expedite wireless communication setup and to enable fast interfaces for wireless data transfer without user intervention. The disclosed embodiments may be implemented at any wireless environment.

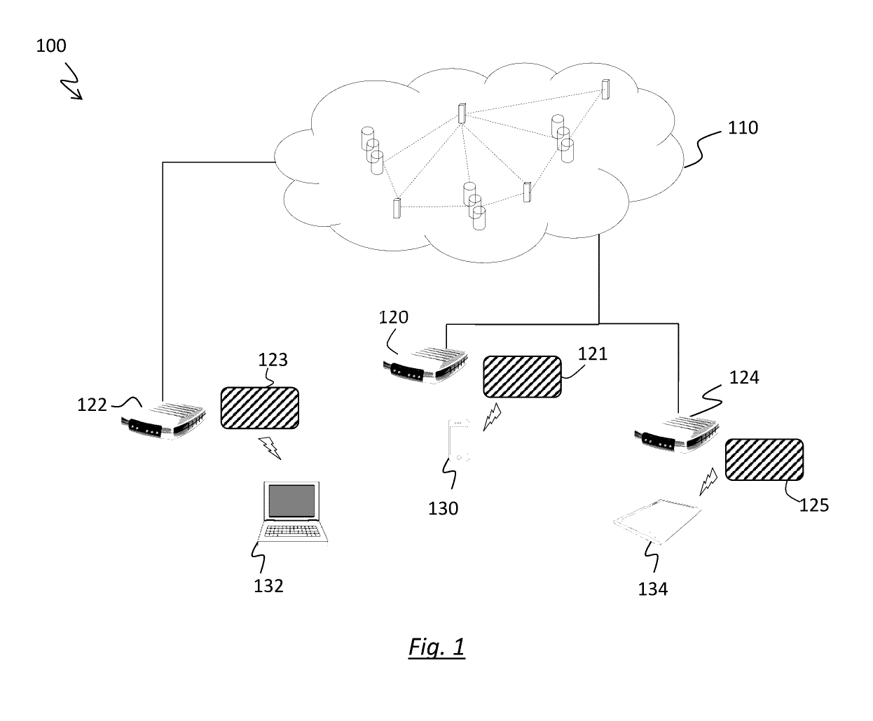

FIG. 1 shows a wireless environment for implementing an embodiment of the disclosure. FIG. 1 schematically illustrates an efficient network for implementing an embodiment of the disclosure. Specifically, FIG. 1 shows network environment 100 having network 110 communicating with Access Points (APs) or docking stations 120, 122 and 124. Each docking station may be associated with a wireless charging pad. FIG. 1 shows, dockings station 122 associated with wireless charging pad 123, docking station 120 associated with wireless charging pad 121 and docking station 124 associated with wireless charging pad 125. Each wireless charging pad 121, 123 and 125 may be configured to provide wireless charging to a mobile device proximate thereto. Further, each wireless charging pad transmits a power signal in the form of a power beacon.

While FIG. 1 shows docking stations 120, 122 and 124 as part of network 110, the disclosed principles are not limited thereto and are equally applicable to environments where the docking station is outside the network. Exemplary mobile devices include smartphones, tablets, laptops, other docking stations or any other wireless device. Mobile devices 130, 132 and 134 may communicate with each other as well as with docking stations 120, 122 and 124. Each of docking stations 120, 122 and 124 may define a different WLAN and may comprise a modem, a router, docking station or any other required circuitry. It should be noted that a docking station may also be implemented as an 802.11 STA. The docking station may also be implemented as PBSS control point PCP under IEEE 802.1 lad definition. Docking stations 120, 122 and 124 may compete with each other and with other devices for the medium. Docking stations 120, 122 and 124 as well as mobile devices 130, 132 and 134 may continually transmit unsolicited data packets to other devices. Such data may include solicitation for connection to other nearby devices.

According to one embodiment of the disclosure, mobile device (130, 132, 134) discovers wireless docking station (120, 122, 124) by first detecting a wireless charging station (121, 123 and 125) associated with a respective docking station (120, 122, 124). Once the appropriate wireless charger is discovered, the mobile device identifies an associated docking station, for example, through a look-up table. After the associated docking station is identified, the mobile station may initiate wireless communication with the docking station. Because magnetic signals from the wireless charging stations are detected much faster than the conventional communication signals, the proposed embodiments expedite communication initiation and handover to faster interface(s) for data communication.

The disclosed embodiments provide many advantages as compared to the conventional methods and systems. Some of the advantages include: quick discovery and connection initiation (in the order of one second or less), process security, avoidance of false detection, minimal cost impact to existing systems, leverages existing technology and low power consumption. These and other advantages over the conventional methods are summarized at TABLE 1 below.

TABLE 1
Relative efficiencies of initial connection methods

| | | Wireless | | |
|---|---|---|---|---|
| Criteria | NFC | Charging | Bluetooth | Wi-Fi Direct |
| Fast | <1 s | <1 s | 1-5 s | 5-10 s |
| Secure | Yes | Yes | Yes | Yes |
| Proximity | Yes (<4 cm) | Yes | No | No |
| | | (<10 cm) | | |
| Cost | Requires an NFC | No | Requires a | No |
| | device on the | (assuming | Bluetooth device | |
| | docking | docking | on the docking | |
| | | includes it) | | |
| Operating | Background | Background | Foreground, | Background: |
| mode | | | Background | power |
| | | | (false | consumption |
| | | | detection/pairing) | impact, false |
| | | | | detection/pairing |
| Handover | Bluetooth (OPP) | Yes (BT | Yes (proprietary) | Not relevant, |
| | WiFi Direct | DOT, future | | Wireless |
| | (WPS + NFC + P2P) | standard) | | docking is |
| | | | | based on Wi-Fi |
| | | | | Direct |

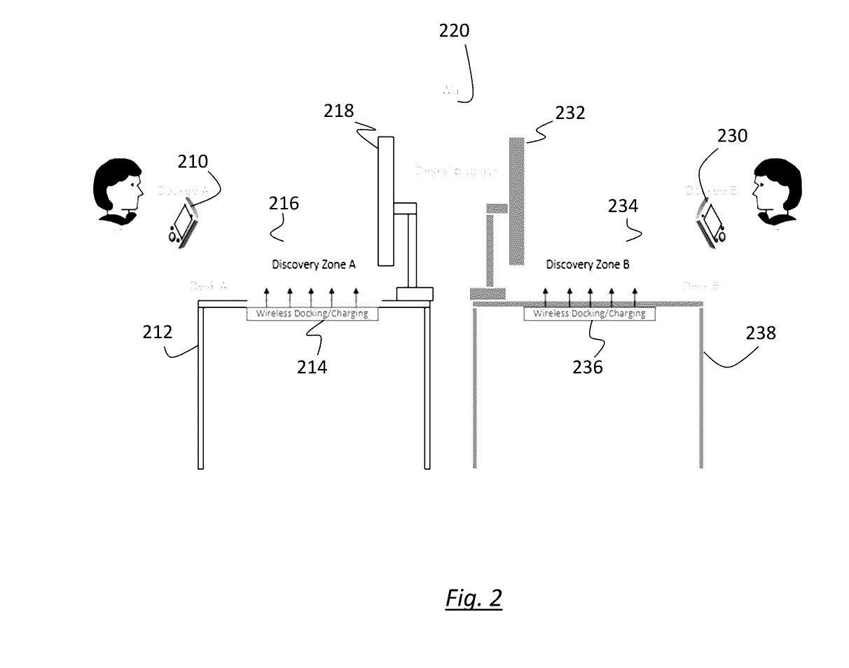

FIG. 2 schematically illustrates an implementation according to one embodiment of the disclosure. Namely, FIG. 2 shows two docking stations serving two mobile devices. In the embodiment of FIG. 2, wireless docking station and wireless charging stations are illustratively combined as wireless docking/charging 214 and 216. Wireless docking/charging station 214 is placed at or near desk 212 on the left-hand-side of wall 220. Wireless docking/charging station 216 is placed at or near desk 238 on the right-hand-side of wall 220. Discovery zone 216 illustrates the magnetic field associated with wireless docking/charging station 214 and discover zone 236 illustrates the magnetic field associated with wireless docking/charging station 216. While magnetic fields 214 and 236 are represented as hemispherical, the disclosure is not limited thereto and the magnetic fields may have any shape or form.

As mobile devices 210 and 230 approach desks 212 and 238, each device senses magnetic fields 216 and 234, respectively. The sensing of the magnetic field sensing may be triggered when each mobile device 210, 230 is sufficiently close to a wireless docking/charging station 214, 236. Because of the magnetic field intensity is significantly reduced further away from the wireless docking/charging station, there is little or no probability of false detection of discovery zone 234 by mobile device 216. Thus, even though desks 212 and 238 are close to each other, there is no cross-connection probability.

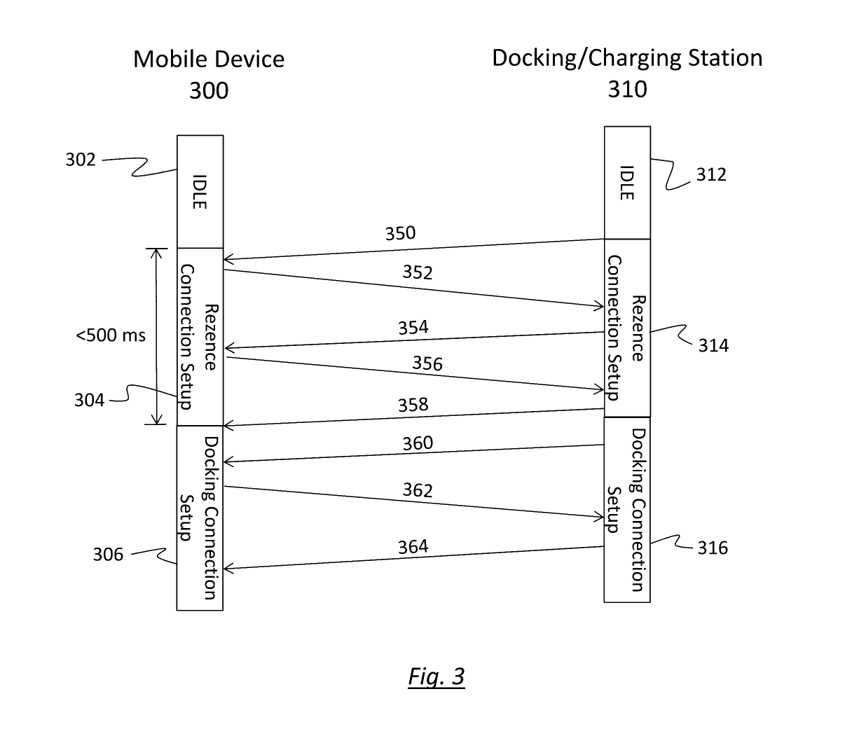

FIG. 3 shows a discovery process according to one embodiment of the disclosure. In FIG. 3, mobile device 300 is sufficiently near docking/charging station 310 to detect a discovery zone (see, e.g., discovery zone 216 of FIG. 2) emitted from wireless docking/charging station 310. Docking/charging device 310 may define a docking station and a charging station as illustrated in FIG. 2. At step 302, 312 both mobile device 300 and docking/charging station 310 are both in idle phase. While at idle, both mobile station 300 and docking/charging station 310 may continue sending and receiving beacon signals or engage in other communication while being idle with respect to each other. At the end of step 312, mobile device 300 is proximal enough to docking/charging station 310 to receive its power beacon signal. This is shown as arrow 350 where power beacon 350 is transmitted from docking/charging station 310 to mobile device 300. Power beacon 350 may be generated as part of the magnetic field of docking/charging station 310. In one embodiment of the disclosure, a common power beacon is used. The Power beacon may be a common procedure used with all AW4P-compatible devices to allow interoperability between every device and charging pad. The power beacon may be a simple pulse providing a quantity of power (mW) depending on the category supported by the charging pad during 100 ms. duration.

At step 352, and in response to detecting power beacon 350, mobile device 301 issues a BLE advertisement which is received by docking/charging station 310. As it is known in the art, BLE devices issue Bluetooth advertising signal denoting device presence. Other BLE devices receiving the advertisement may respond to the BT/BLE advertisement in order to arrange BLE connection. While in the embodiment of FIG. 3, BLE connection is used, the disclosure is not limited thereto and other communication methodology may be used without departing from the disclosed principles. That is, mobile device 300 may detect power beacon signal and activate a communication signal in response thereto. For example, a Wi-Fi communication may be initiated in response to detecting power beacon 350. The initiation of a communication signal in response to the power beacon 350 expedites communication between mobile device 300 and docking/charging stations 310.

At step 354 docking/charging station 310 issues a BLE Connection request to mobile device 300. In response to the BLE connection request 354, mobile device 300 transmits connection information and/or credentials to docking/charging station 310 at step 356. At step 358, docking/charging station 310 enables charging of mobile device 300. In one exemplary embodiment, the docking/charging station 310 may be configured to charge all chargeable devices while enabling wireless communication only with one or more approved devices. In another embodiment, the docking/charging station 310 may be configured to charge only approved devices. In this embodiment, docking/charging station 310 may identify mobile device 300 (e.g., through device identifier, MAC address or other conventional means) and determine based on a predefined rules whether mobile device 300 is an approved device.

In one embodiment of the disclosure, the very first discovery between mobile device 300 and docking/charging station 310 relies on the Rezence wireless charging discovery which is used to start the charging. The period of time from detection of power beacon 350 to the time charging is enabled is shown in FIG. 3 as Rezence connection setup 304 (mobile device 300) and 314 (docking/charging station 310). Conventionally, Rezence is an interface standard developed by the A4WP for wireless electrical power transfer based on the principles of magnetic resonance. The Rezence phase must last less than 500 msec to comply with the Rezence test specification. The Rezence system consists of a single power transmitter unit (i.e., docking/charging station 310) and one or more power receiver units (i.e., mobile device 300). The interface standard supports power transfer up to 50 Watts, at distances up to 5 centimeters. The power transmission frequency is 6.78 MHz, and up to eight devices can be powered from a single power transfer unit depending on transmitter and receiver geometry and power levels. A BLE link is defined in the A4WP system for controlling of power levels, identification of valid loads and protection of non-compliant devices. In one implementation of the disclosure, the Rezence period is less than 500 msec.

The docking connection setup 306, 316 proceeds the Rezence connection period 304, 314. During this phase, mobile device 300 is made discoverable which allows docking/charging station 310 to read the docking service. Immediately after this procedure (in red in the above drawing) is where the invention stands. One embodiment of the disclosure aims to have a new BLE service implemented in both mobile device 300 and docking/charging station 310 which enables the required information exchange to start the Wi-Fi P2P connection. During the setup period 306, 316, docking/charging station 310 sends message 360 to mobile device 300 providing BLE read docking service. The BLE read docking service message requests basic identification information from mobile device 300.

At step 362 and in response to the BLE read docking service request, mobile device 300 transmits information including, MAC address, channel identification number and other information required to setup communication between mobile device 300 and docking/charging station 310. In one embodiment device 300 sends the receiving P2P device attribute information as specified by the WFA P2P standard.

At step 364, docking/charging station 310 transmits connection information including Wi-Fi peer-to-peer information. At this time a Wi-Fi connection is made between docking/charging station 310 and mobile device 300. Using the power beacon as a trigger to start communication initiation between mobile device 300 and docking/charging station 310 significantly improves the speed by which communication connection is made.

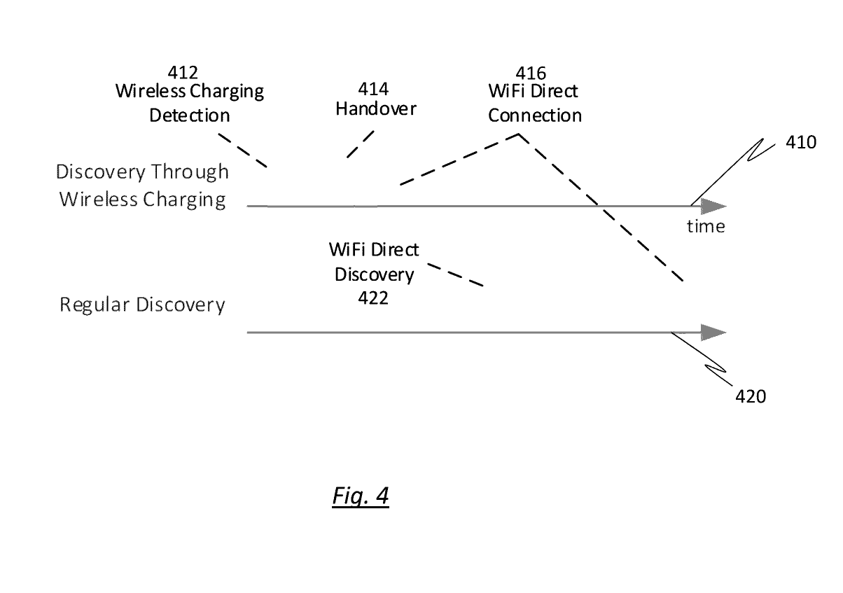

FIG. 4 illustrates the significant improvement in connection speed provided by the disclosed principles when compared to conventional methods. Specifically, the process outline in FIG. 2 is represented by time-axis 410 and the conventional discovery process is represented by axis 420. The conventional process or regular Wi-Fi direct discovery typically takes about 10 seconds. The disclosed embodiment provides the same connection in the order of milliseconds. As illustrates in FIG. 4, discovery through wireless charging includes the steps of wireless charging detection 412, handover procedure 414 and Wi-Fi direct connection 416. These steps are significantly shorter than the step of Wi-Fi discovery 422 and connection setup 416. Clearly, avoiding the Wi-Fi direct discovery process 422 shortens the connection period. While FIG. 4 illustrates the Wi-Fi connection methodology, the disclosed principles may be equally applied to Wi-Gig connection process.

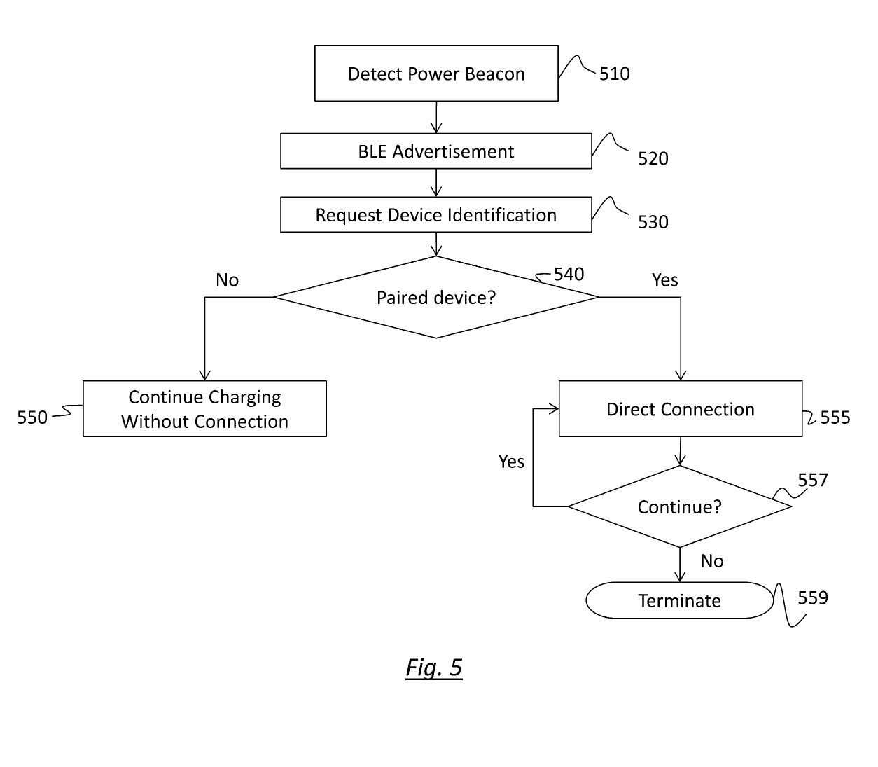

FIG. 5 shows a flow-diagram for implementing an embodiment of the disclosure. The connection process of FIG. 5 is independent of the transport and physical layer. The flow-diagram of FIG. 5 starts at step 510 when the mobile device detects a power beacon. Typically, a proximity of 10 cm or less is needed to detect power beacon. In one embodiment of the disclosure the power beacon may be repeated every three seconds and may last about 100 msec. The power beacon may be detected when a mobile device approaches or nears a wireless charging station. The wireless charging station may be integrated with a wireless docking station. The power beacon may comprise a magnetic field used to trigger a BLE communication session between the wireless charging/docking station and the proximal mobile device.

At step 520, the handover process is initiated when the mobile device transmits a BLE advertisement to wireless docking/charging station. The docking/charging station responds by requesting identification information from the mobile device at step 530. In an exemplary embodiment, the discovery mechanism is done using BLE. Thereafter, the BLE may handover communication mode to Wi-Fi P2P. The Wi-Fi handover may be aided by data exchanged beforehand (MAC@, channel identification number, etc.) through the BLE communication. To perform the hand over either BLE discovery-of-things profile, exiting profile or other known profiles may be used.

At step 540 determination is made as to whether the mobile device has been approved for pairing to the docking station. If the mobile device is not identified as a device associated with the docking station (i.e., a device not previously paired with the docking station), the connection initiation process continues as shown at step 550. The identification process may be implemented at the wireless docking/charging station. In another embodiment the determination may be made at the mobile device if the mobile device obtains identification information from the wireless docking/charging station.

If on the other hand, the mobile device is identified as a device associated with the docking station (i.e., a device which was previously paired with the docking station), the connection initiation process continues as shown at step 555. The connection process may, for example, start the Wi-Fi or Wi-Gig connection process and exchange information required for communication setup between the mobile device and the wireless docking/charging station. Conventional processes for setting up and maintaining the Wi-Fi, Wi-Gig or other communication forms may be implemented.

In an exemplary embodiment, the wireless docking/charging station may optionally monitor proximity of the mobile device. This is shown in optional step 557. This step may be done by polling the mobile device or receiving periodic advertisement from the device. If the mobile device is removed from the wireless docking/charging station, the connection may be terminated as shown in step 559. Otherwise, the termination may be maintained as shown.

The steps of flow-diagram 5 may be implemented in hardware, software or a combination of hardware and software. In one embodiment of the disclosure, the steps may be stored as instructions in a memory to direct one or more processors to implement these steps. In another embodiment, the disclosure includes a non-transitory computer-readable storage device comprising a set of instructions to direct one or more processors to perform the steps outlined herein. The processors may be comprise one or more processing circuity, virtual logic or a combination of processing circuity and operating virtual logic.

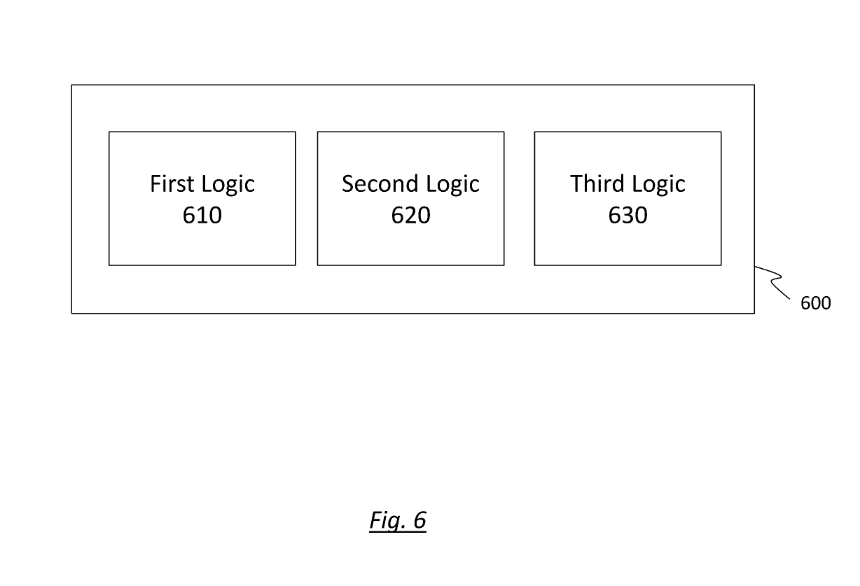

FIG. 6 schematically illustrates an apparatus for implementing an embodiment of the disclosure. The apparatus of FIG. 6 can be an integral part of a larger system or can be a stand-alone unit. For example, device 600 may define a system-on-chip (SOC) configured to implement the disclosed methods. Device 600 may also be part of a larger system having one or more antennas, one or more radios and one or more processors and memory systems. Device 600 may be integrated with a mobile device. Device 600 may define a software or an app which can be configured into an existing controller to enable the disclosed functionalities. While not shown, in an exemplary embodiment, device 600 may be integrated with a wireless system to thereby include one or more antennas (directed to different communication forms including Bluetooth, Wi-Fi, Wi-Gig, NFC, etc.), transmitters, radios (for processing analog signals to digital data stream and vice-versa) and one or more coils for generating a magnetic field for power transfer (e.g., PTU and/or PRU).

Device 600 is shown with first logic 610, second logic 620 and third logic 630. Each logic may further comprise one or more processor (actual or virtual) and circuitry. Further, each logic may be implemented on hardware, software or both. In one embodiment, first logic 610 can be configured to detect a power beacon transmitted from a wireless charging station (not shown). Second logic 620 may communicate with the first logic. Second logic 620 may be configured to transmit a signal to the wireless charging station. Second logic 620 may further be configured to transmit mobile device identification information to the wireless charging station (not shown). Third logic 630 may communicate with one or more of first logic 610 or second logic 630. Third logic 630 may be configured to initiate wireless communication with the wireless charging station if the mobile device identification information identifies the mobile device as a device previously paired with the wireless charging station.

The following are provided to illustrate exemplary and non-limiting embodiments of the disclosed principles. Example 1 is directed to an apparatus comprising one or more processors and circuitry, the circuitry including: a first logic to detect a power beacon transmitted from a wireless charging station; a second logic to communicate with the first logic and to transmit a signal to the wireless charging station, the second logic further configured to transmit mobile device identification information to the wireless charging station; and at third logic to communicate with one or more of the first or the second logic, the third logic to initiate wireless communication with the wireless charging station if the mobile device identification information identifies the mobile device as a device previously paired with the wireless charging station.

Example 2 is directed to the apparatus of example 1, wherein the signal defines a BLE

Advertisement.

Example 3 is directed to the any of the previous example, wherein the first module is configured to detect a power beacon from a wireless charging station associated with a wireless docking station.

Example 4 is directed to any of the previous examples, wherein the wireless communication comprise one or more of Wi-Fi, Wi-Gig or Bluetooth (BT) communication.

Example 5 is directed to any of the previous examples, wherein the third module is further configured to terminate wireless communication with the mobile device if the mobile device identification information identifies the mobile device as a device not previously paired with the wireless charging station.

Example 6 is directed to any of the previous examples, wherein the third module is further configured to continue charging the mobile device if the mobile device identification information identifies the mobile device as a device not previously paired with the wireless charging station.

Example 7 is directed to a method to provide low power wireless docking discovery to a mobile device, the method comprising: detecting, at a mobile device, a power beacon transmitted from a wireless charging station; responsive to the power beacon detection, transmitting a BLE Advertisement signal; receiving a connection request from the wireless charging station; transmitting mobile device information to the wireless charging station; and initiating wireless communication between the mobile device and the wireless charging station when mobile device information identifies the mobile device as a previously paired device.

Example 8 is directed to the method of example 7, wherein the wireless charging station further comprises a wireless docking station.

Example 9 is directed to the method of any of examples 7-8, further comprising receiving a BLE connection request from the wireless charging station.

Example 10 is directed to the method of any of examples 7-9, wherein the wireless communication comprise one or more of Wi-Fi, Wi-Gig or Bluetooth (BT) communication.

Example 11 is directed to the method of any of examples 7-10, further comprising charging the mobile device.

Example 12 is directed to the method of any of examples 7-11, further comprising terminating wireless communication between the mobile device and the wireless charging station when mobile device information identifies the mobile device as a device not previously paired with the wireless charging station.

Example 13 is directed to the method of any of examples 7-12, further comprising terminating charging the mobile device when mobile device information identifies the mobile device as a device not previously paired with the wireless charging station.

Example 14 is directed to a non-transitory computer-readable storage device comprising a set of instructions to direct one or more processors to: detect, at a mobile device, a power beacon transmitted from a wireless charging station; responsive to the power beacon detection, transmit a BLE Advertisement signal; receive a connection request from the wireless charging station; transmit mobile device information to the wireless charging station; and initiate wireless communication between the mobile device and the wireless charging station when mobile device information identifies the mobile device as a previously paired device.

Example 15 is directed to the non-transitory computer-readable storage device of example 14, wherein the wireless charging station further comprises a wireless docking station.

Example 16 is directed to the non-transitory computer-readable storage device of examples 14 and/or 15, wherein the instructions further directed the one or more processors to receive a BLE connection request from the wireless charging station.

Example 17 is directed to the non-transitory computer-readable storage device of examples 14-16, wherein the wireless communication comprise one or more of Wi-Fi, Wi-Gig or Bluetooth (BT) communication.

Example 18 is directed to the non-transitory computer-readable storage device of examples 14-17, wherein the instructions further direct the one or more processors to charge the mobile device.

Example 19 is directed to the non-transitory computer-readable storage device of examples 14-18, wherein the instructions further direct the one or more processors to transmit wireless communication between the mobile device and the wireless charging station when mobile device information identifies the mobile device as a device not previously paired with the wireless charging station.

Example 20 is directed to the non-transitory computer-readable storage device of examples 14-19, wherein the instructions further direct the one or more processors to terminate charging the mobile device when mobile device information identifies the mobile device as a device not previously paired with the wireless charging station.

While the principles of the disclosure have been illustrated in relation to the exemplary embodiments shown herein, the principles of the disclosure are not limited thereto and include any modification, variation or permutation thereof.

What is claimed is:

1. An apparatus comprising one or more processors and circuitry, the circuitry including:
a first logic to detect a power beacon transmitted from a wireless charging station;
a second logic to communicate with the first logic and to transmit a signal to the wireless charging station, the second logic further configured to transmit mobile device identification information to the wireless charging station; and
at third logic to communicate with one or more of the first or the second logic, the third logic to initiate wireless communication with the wireless charging station if the mobile device identification information identifies the mobile device as a device previously paired with the wireless charging station.

2. The apparatus of claim 1, wherein the signal defines a BLE Advertisement.

3. The apparatus of claim 1, wherein the first module is configured to detect a power beacon from a wireless charging station associated with a wireless docking station.

4. The apparatus of claim 1, wherein the wireless communication comprise one or more of Wi-Fi, Wi-Gig or Bluetooth (BT) communication.

5. The apparatus of claim 1, wherein the third module is further configured to terminate wireless communication with the mobile device if the mobile device identification information identifies the mobile device as a device not previously paired with the wireless charging station.

6. The apparatus of claim 1, wherein the third module is further configured to continue charging the mobile device if the mobile device identification information identifies the mobile device as a device not previously paired with the wireless charging station.

7. A method to provide low power wireless docking discovery to a mobile device, the method comprising:
detecting, at a mobile device, a power beacon transmitted from a wireless charging station;
responsive to the power beacon detection, transmitting a BLE Advertisement signal;
receiving a connection request from the wireless charging station;
transmitting mobile device information to the wireless charging station; and
initiating wireless communication between the mobile device and the wireless charging station when mobile device information identifies the mobile device as a previously paired device.

8. The method of claim 7, wherein the wireless charging station further comprises a wireless docking station.

9. The method of claim 7, further comprising receiving a BLE connection request from the wireless charging station.

10. The method of claim 7, wherein the wireless communication comprise one or more of Wi-Fi, Wi-Gig or Bluetooth (BT) communication.

11. The method of claim 7, further comprising charging the mobile device.

12. The method of claim 7, further comprising terminating wireless communication between the mobile device and the wireless charging station when mobile device information identifies the mobile device as a device not previously paired with the wireless charging station.

13. The method of claim 7, further comprising terminating charging the mobile device when mobile device information identifies the mobile device as a device not previously paired with the wireless charging station.

14. A non-transitory computer-readable storage device comprising a set of instructions to direct one or more processors to:
detect, at a mobile device, a power beacon transmitted from a wireless charging station;
responsive to the power beacon detection, transmit a BLE Advertisement signal;
receive a connection request from the wireless charging station;
transmit mobile device information to the wireless charging station; and
initiate wireless communication between the mobile device and the wireless charging station when mobile device information identifies the mobile device as a previously paired device.

15. The non-transitory computer-readable storage device of claim 14, wherein the wireless charging station further comprises a wireless docking station.

16. The non-transitory computer-readable storage device of claim 14, wherein the instructions further directed the one or more processors to receive a BLE connection request from the wireless charging station.

17. The non-transitory computer-readable storage device of claim 14, wherein the wireless communication comprise one or more of Wi-Fi, Wi-Gig or Bluetooth (BT) communication.

18. The non-transitory computer-readable storage device of claim 14, wherein the instructions further direct the one or more processors to charge the mobile device.

19. The non-transitory computer-readable storage device of claim 14, wherein the instructions further direct the one or more processors to transmit wireless communication between the mobile device and the wireless charging station when mobile device information identifies the mobile device as a device not previously paired with the wireless charging station.

20. The non-transitory computer-readable storage device of claim 14, wherein the instructions further direct the one or more processors to terminate charging the mobile device when mobile device information identifies the mobile device as a device not previously paired with the wireless charging station.
